(19) United States
(12) Patent Application Publication
(10) Pub. No.: US 2018/0036903 A1
(43) Pub. Date: Feb. 8, 2018

(54) CHAINSAW CHAIN WITH MODIFIED CUTTER LINKS

(71) Applicant: HUSQVARNA AB, HUSKVARNA (SE)

(72) Inventors: Adam Ståhlkrantz, Huskvarna (SE); Niklas Sarius, Jönköping (SE)

(21) Appl. No.: 15/555,106

(22) PCT Filed: Mar. 1, 2016
(86) PCT No.: PCT/IB2016/051141

§ 371 Date: Sep. 1, 2017

Related U.S. Application Data
(60) Provisional application No. 62/128,155, filed on Mar. 4, 2015.

(51) Int. Cl. B27B 33/14; B27B 17/02

(52) U.S. Cl. CPC B27B 33/142; B27B 17/025

(57) ABSTRACT

A method of modifying a cutter link (240) of cutting chain (200) for a chainsaw (100) may include forming the cutter link (240) to include a base portion (280) and a cutting portion (270) extending away from the base portion (280). The cutting portion (270) may include a side plate (300/500) and a top plate (310/510). The top plate (310/510) may include a top plate leading edge (312/412/512) and a bottom face (314/414/514). The side plate (300/500) may include a side plate leading edge (302/402/502) and an inside face (304/404/504). The method may further include removing at least a portion of material forming the bottom face (314/414/514). The portion of material forming the bottom face (314/414/514) that is removed decreases as distance from the top plate leading edge (312/412/512) increases.

### CROSS REFERENCE TO RELATED APPLICATION

This application claims priority to U.S. provisional application No. 62/128,155 filed on Mar. 4, 2015, the entire contents of which are incorporated herein by reference.

### TECHNICAL FIELD

Example embodiments generally relate to hand held power equipment and, more particularly, relate to cutting chain improvements for a chainsaw.

### BACKGROUND

Chainsaws are commonly used in both commercial and private settings to cut timber or perform other rigorous cutting operations. Because chainsaws are typically employed in outdoor environments, and the work they are employed to perform often inherently generates debris, chainsaws are typically relatively robust hand held machines. They can be powered by gasoline engines or electric motors (e.g., via batteries or wired connections) to turn a chain around a guide bar at relatively high speeds. The chain includes cutting teeth that engage lumber or another medium in order to cut the medium as the teeth are passed over a surface of the medium at high speed.

Given that the chainsaw may be employed to cut media of various sizes and types, it should be appreciated that the design of the chain itself may have an impact on the effectiveness of the cutting operations. As such, it may be desirable to explore a number of different chain design improvements that could be employed alone or together with other design changes to improve overall chainsaw, and cutting chain, performance.

### BRIEF SUMMARY OF SOME EXAMPLES

Some example embodiments may provide for a chainsaw chain constructed with a modification to cutter links to improve cutting efficiency. The modification to the cutter links of the chain may improve cutting efficiency and minimize the energy required for executing the cutting procedure. The modification, which involves removing material from an underside of the top plate of the cutter link (and in some cases also involves removal of material on the side plate) may improve stay sharp properties of the chain and provide better out of the box performance. Other improvements may also be possible, and the improvements can be made completely independent of each other, or in combination with each other in any desirable configuration. Accordingly, the operability and utility of the chainsaw may be enhanced or otherwise facilitated.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a chainsaw according to an example embodiment;

FIG. 2 illustrates a side view of a chainsaw guide bar employing a chain according to an example embodiment;

FIG. 3 illustrates a perspective side view of one cutter link in accordance with an example embodiment;

FIG. 4, which includes FIGS. 4A, 4B, 4C and 4D, illustrates perspective views of a base cutter link (FIG. 4A) and various modifications (FIGS. 4B, 4C and 4D) that may be made in accordance with an example embodiment;

FIG. 5, which includes FIGS. 5A, 5B, 5C, 5D and 5E, illustrates perspective views of another base cutter link (FIG. 5A) and various modifications (FIGS. 5B, 5C, 5D and 5E) that may be made in accordance with an example embodiment;

FIG. 6 illustrates a block diagram of a method for modifying a cutter link in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

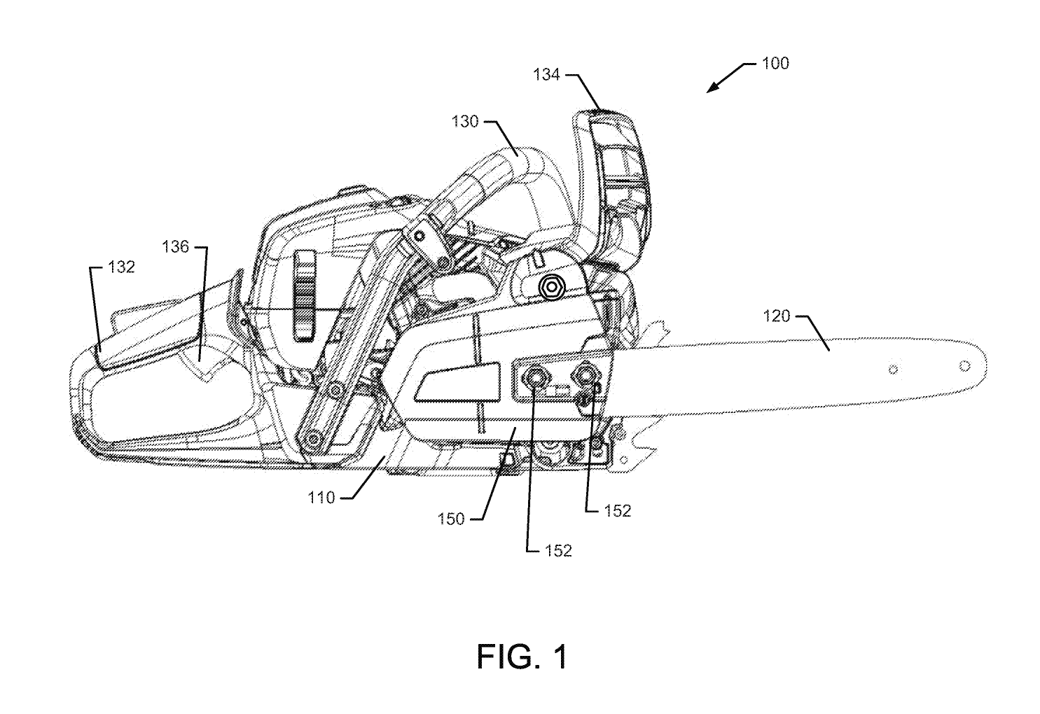

FIG. 1 illustrates side view of a chainsaw 100 according to an example embodiment. As shown in FIG. 1, the chainsaw 100 may include a housing 110 inside which a power unit or motor (not shown) is housed. In some embodiments, the power unit may be either an electric motor or an internal combustion engine. Furthermore, in some embodiments, the power unit may include more than one electric motor where one such electric motor powers the working assembly of the chainsaw 100 and the other electric motor of the power unit powers a pump that lubricates the working assembly or provides momentum for moving other working fluids within the chainsaw 100. The chainsaw 100 may further include a guide bar 120 that is attached to the housing 110 along one side thereof. A chain (not shown) may be driven around the guide bar 120 responsive to operation of the power unit in order to enable the chainsaw 100 to cut lumber or other materials. The guide bar 120 and the chain may form the working assembly of the chainsaw 100. As such, the power unit may be operably coupled to the working assembly to turn the chain around the guide bar 120.

The chainsaw 100 may include a front handle 130 and a rear handle 132. A chain brake and front hand guard 134 may be positioned forward of the front handle 130 to stop the movement of the chain 122 in the event of a kickback. In an example embodiment, the hand guard 134 may be tripped by rotating forward in response to contact with a portion of the arm (e.g., the hand/wrist) of the operator of the chainsaw 100. In some cases, the hand guard 134 may also be tripped in response to detection of inertial measurements indicative of a kickback.

The rear handle 132 may include a trigger 136 to facilitate operation of the power unit when the trigger 136 is actuated. In this regard, for example, when the trigger 136 is actuated (e.g., depressed), the rotating forces generated by the power unit may be coupled to the chain either directly (e.g., for electric motors) or indirectly (e.g., for gasoline engines). The term “trigger,” as used herein, should be understood to represent any actuator that is capable of being operated by a hand or finger of the user. Thus, the trigger 136 may represent a button, switch, or other such component that can be actuated by a hand or portion thereof.

Some power units may employ a clutch to provide operable coupling of the power unit to a sprocket that turns the chain. In some cases (e.g., for a gasoline engine), if the trigger 136 is released, the engine may idle and application of power from the power unit to turn the chain may be stopped. In other cases (e.g., for electric motors), releasing the trigger 136 may secure operation of the power unit. The housing 110 may include a fuel tank for providing fuel to the power unit. The housing 110 may also include or at least partially define an oil reservoir, access to which may be provided to allow the operator to pour oil into the oil reservoir. The oil in the oil reservoir may be used to lubricate the chain as the chain is turned.

As can be appreciated from the description above, actuation of the trigger 136 may initiate movement of the chain around the guide bar 120. A clutch cover 150 may be provided to secure the guide bar 120 to the housing 110 and cover over the clutch and corresponding components that couple the power unit to the chain (e.g., the sprocket and clutch drum). As shown in FIG. 1, the clutch cover 150 may be attached to the body of the chainsaw 100 (e.g., the housing 110) via nuts 152 that may be attached to studs that pass through a portion of the guide bar 120. The guide bar 120 may also be secured with the tightening of the nuts 152, and a tightness of the chain can be adjusted based on movement of the guide bar 120 and subsequent tightening of the nuts 152 when the desired chain tightness is achieved. However, other mechanisms for attachment of the clutch cover 150 and/or the guide bar 120 may be provided in other embodiments including, for example, some tightening mechanisms that may combine to tighten the chain in connection with clamping the guide bar 120.

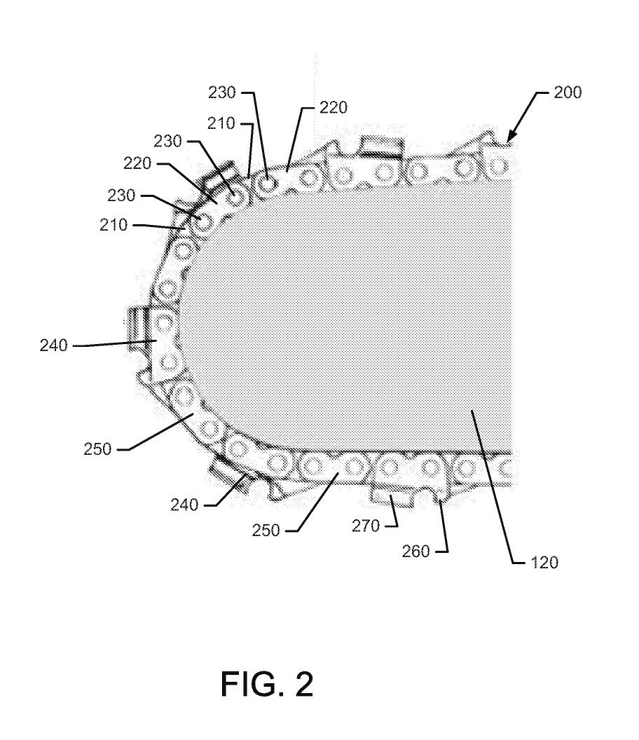

In some embodiments, the guide bar 120 may be formed from two laminate core sheets that lie in parallel planes along side each other to define a channel around a periphery of the guide bar 120. The chain (or at least a portion of the chain) may ride in the channel, as the rest of the chain rides along the periphery of the guide bar 120 to engage media for cutting. FIG. 2 illustrates a typical chain 200 disposed on the guide bar 120. The chain 200 includes a plurality of center drive links 210 that each include a portion thereof that rides in the channel. Each center drive link 210 is attached to an adjacent pair of side links 220 by rivets 230 that extend perpendicular to the longitudinal length of the links. A rivet 230 is provided at the front portion of each center drive link 210 to attach the center drive link 210 to the rear portion of a preceding side links 220 and another rivet 230 is provided at the rear portion of each center drive link 210 to attach the center drive link 210 to the front portion of a subsequent side links 220. As such, each pair of side links 220 connects to opposing sides of the center drive links 210, and the connections are repeated in alternating fashion to complete a circular or endless chain.

For some pairs of side links 220 of the chain 200 one of the side links may be formed as a cutter link 240. Meanwhile, pairs of side links that do not include a cutter link 240 may be referred to as tie links 250. The cutter links 240 may be provided with two portions including a depth gauge portion 260 and a cutting portion 270. The cutting portion 270 may generally engage material that extends beyond the depth of the depth gauge portion 260 when the chain 200 is rotated. Meanwhile, the tie links 250 may not include cutting portions or depth gauge portions and may be provided to simply extend the length of the chain 200 while providing a space between portions of the chain 200 that will create friction during cutting operations. If every side link 210 was a cutter link 240, the friction on the chain 200 would be very high, and it would be difficult to provide sufficient power to turn the chain, and control of the chainsaw 100 could also become difficult.

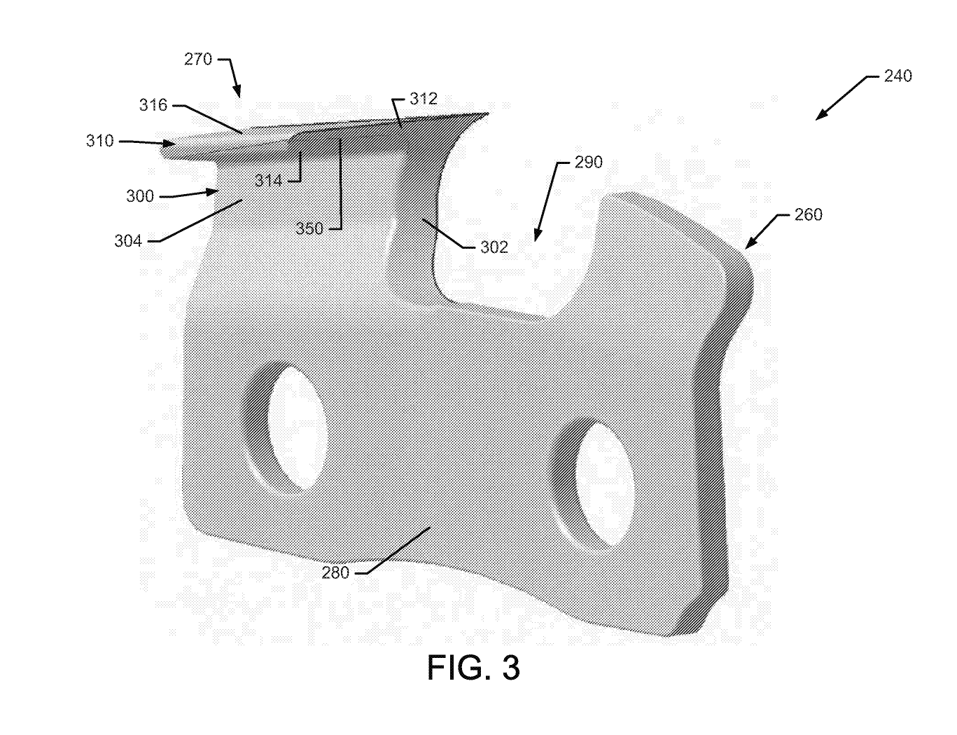

As shown in FIG. 3, the cutter links 240 may have a base portion 280 from which both the cutting portion 270 and the depth gauge portion 260 extend. The rivets may be passed through holes in the base portion 280. The cutting portion 270 may extend away from the base portion 280 in the same direction that the depth gauge portion 260 extends away from the base portion 280. However, the depth gauge portion 260 may be at one end of the cutter link 240 and the cutting portion 270 may be at the other end, separated from each other by a gap 290. Of note, the gap 290 may grow in size over time, as the cutting portion 270 is worn or abraded away due to use.

The cutting portion 270 may include a side plate 300 that extends upward away from the base portion 280. Although the side plate 300 generally extends in a direction parallel to plane in which the base portion 280 lies, the side plate 300 does not necessarily also lie in the same plane. In some cases, the side plate 300 may have a curved shape to bend slightly out of the plane. Moreover, in some embodiments, the side plate 300 may bend out of the plane and then back toward the plane as it extends away from the base portion 280. Regardless, the distal end of the side plate 300 may be joined with a top plate 310. The top plate 310 may lie in a plane that is substantially perpendicular to the plane in which the base portion 280 lies.

The side plate 300 may have a leading edge 302 and an inside face 304. The side plate may also have an outside face that is opposite the inside face 304, and a trailing edge that is opposite the leading edge 302. The top plate 310 may have a leading edge 312 that extends substantially perpendicular to the direction of extension of the base 280 (and in some cases also the direction of extension of the leading edge 302 of the side plate 300). The top plate 310 may also have a bottom face 314 and a top face 316. The top face 316 may be opposite the bottom face 314 and, in some cases, the top and bottom faces 316 and 314 may be in parallel planes. However, in some cases, the top and bottom faces 316 and 314 may be angled slightly toward each other as they extend away from the side plate 300. Regardless of the slope extending away from the side plate 300, the distance between the top face 316 and the bottom face 314 is generally consistent when moving from the leading edge 312 to the trailing edge along any line that is parallel to the plane in which the base portion 280 lies. The top plate 310 may also have a trailing edge disposed opposite the leading edge 312.

In an example embodiment, the cutter link 240 may be formed by stamping, grinding and combinations thereof with or without other techniques also being employed. To execute a modification of the cutter link 240 in accordance with an example embodiment, stamping, grinding or other processes may be employed to remove material from at least a portion of the bottom face 314 of the top plate 310. FIG. 3 illustrates a line 350 approximating a removal line below which material of the bottom face 314 may be removed in accordance with an example embodiment. As can be appreciated from FIG. 3, the amount of material removed is greater near the leading edge 312 of the top plate 310, and decreases as distance from the leading edge 312 increases. In some cases, no material is removed from the bottom face 314 proximate to the trailing edge of the top plate 310.

The removal of material below the removal line 350 may enhance the cutting efficiency and stay sharp properties of the cutter link 240. In this regard, the removal of some material may reduce friction to obtain better out of box properties. Since there is a slope to the removal line 350, the top face 316 and the bottom face 314 may no longer have the same distance therebetween when moving from the leading edge 312 to the trailing edge along any line that is parallel to the plane in which the base portion 280 lies. However, the effect of the modification will decrease over time (e.g., as the leading edge 312 retreats due to wear and abrasion). Thus, the slope eventually ends near the end of life. As such, the distance between the top face 316 and the bottom face 314 at the leading edge 312 may increase over time.

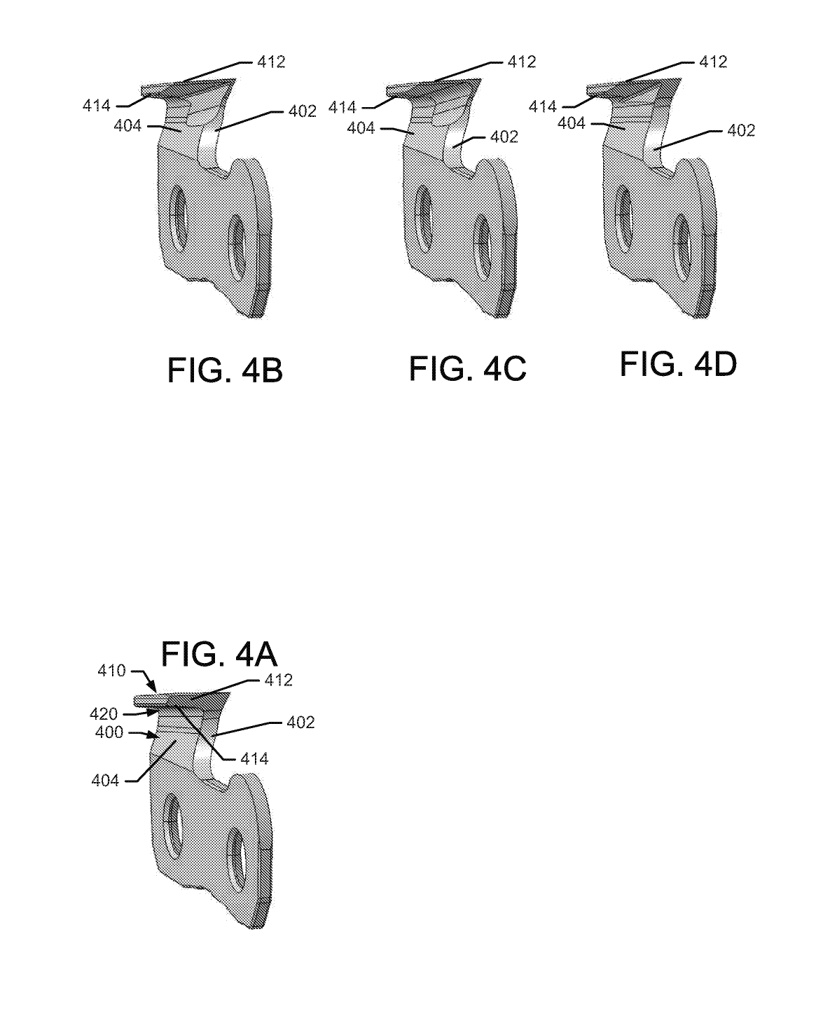

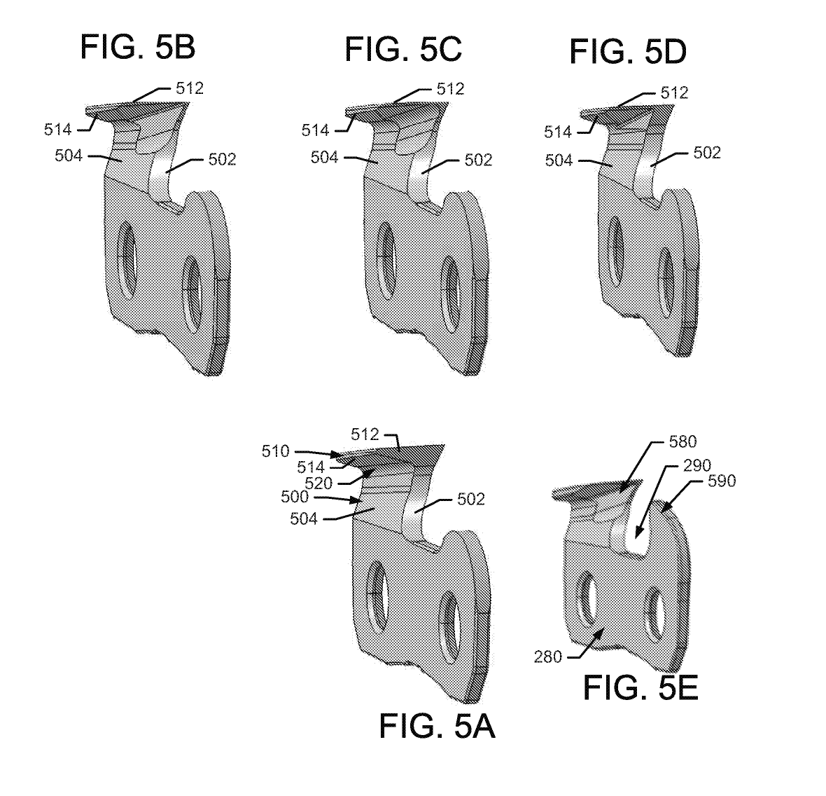

In some embodiments, the modification of the cutter link 240 may involve removal of at least a portion of the bottom face 314 of the top plate 310 and a portion of the inside face 304 of the side plate 300. This further modification is illustrated in reference to FIGS. 4 and 5.

As shown in FIG. 4, a base model cutter link is shown in FIG. 4A and may initially be formed to have a side plate 400 with a leading edge 402 and inside face 404. The cutter link may also have a top plate 410 having a leading edge 412 and a bottom face 414. The leading edge of 412 of the top plate 410 may extend substantially perpendicularly with respect to the leading edge 402 of the side plate 400, and the inside face 404 may meet the bottom face 414 at an interface portion 420 that may be curved. As mentioned above, material may be removed from the bottom face 414 (e.g., by grinding) such that the amount of material removed decreases as distance from the leading edge 412 of the top plate 410 increases. In each of FIGS. 4B, 4C and 4D, the slope of the removal line is substantially similar. However, the amount of material removed from the inside face 404 of the side plate 400 is different in FIGS. 4B, 4C and 4D. In this regard, FIG. 4D does not include any material removed from the side plate 400. Thus, material is only removed from the bottom face 414. In FIG. 4C, some material is removed also from the inside face 404, and the amount of material removed decreases as distance from the leading edge 402 of the side plate 400 increases. In FIG. 4B, even more material is removed from the inside face 404. However, the amount of material still generally decreases as distance from the leading edge 402 of the side plate 400 increases.

FIG. 5 illustrates a similar example with a different base model. Again, the base model cutter link shown in FIG. 5A is initially formed to have a side plate 500 with a leading edge 502 and inside face 504. The cutter link may also have a top plate 510 having a leading edge 512 and a bottom face 514. A difference between the base models of FIGS. 4 and 5 is that the top plate 510 tapers more on the example of FIG. 5 as the top plate 510 extends away from its interface with the side plate 500.

In this example as well, the leading edge of 512 of the top plate 510 may extend substantially perpendicularly with respect to the leading edge 502 of the side plate 500, and the inside face 504 may meet the bottom face 514 at an interface portion 520 that may be curved. As mentioned above, material may be removed from the bottom face 514 (e.g., by grinding) such that the amount of material removed decreases as distance from the leading edge 512 of the top plate 510 increases. In each of FIGS. 5B, 5C and 5D, the slope of the removal line is substantially similar. However, the amount of material removed from the inside face 504 of the side plate 500 is different in FIGS. 5B, 5C and 5D. In this regard, FIG. 5D does not include any material removed from the side plate 500. Thus, material is only removed from the bottom face 514. In FIG. 5C, some material is removed also from the inside face 504, and the amount of material removed decreases as distance from the leading edge 502 of the side plate 500 increases. In FIG. 5B, even more material is removed from the inside face 504. However, the amount of material still generally decreases as distance from the leading edge 502 of the side plate 500 increases. FIG. 5E illustrates another example in which material is removed from both the side plate 500 and the top plate 510 to form a cutter link trench 580 that extends from the top plate 510 downward toward the base portion 280. Moreover, as shown in FIG. 5E, a depth gauge 590 may extend upward from the base portion 280 in front of the gap 290 by an amount sufficient to have a top of the depth gauge end in between the top and bottom of the cutter link trench 580.

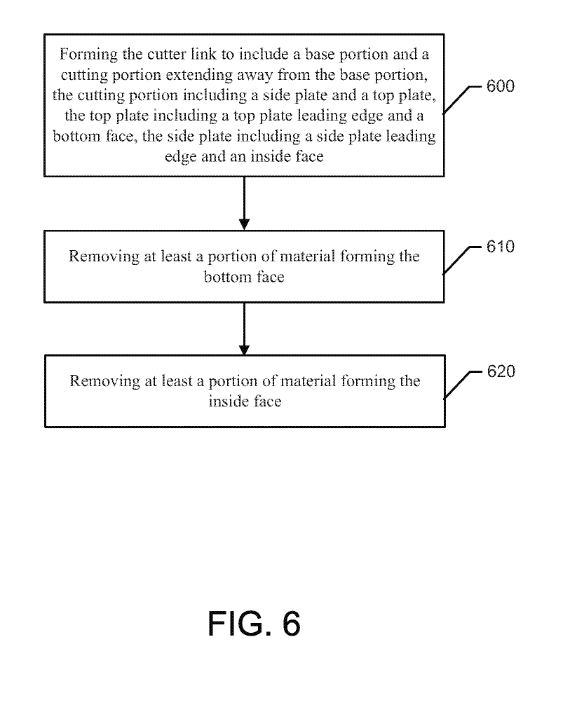

FIG. 6 illustrates a block diagram of a method of modifying a cutter link of cutting chain for a chainsaw. The method may include forming the cutter link to include a base portion and a cutting portion extending away from the base portion at operation 600. The cutting portion may include a side plate and a top plate. The top plate may include a top plate leading edge and a bottom face. The side plate may include a side plate leading edge and an inside face. The method may further include removing at least a portion of material forming the bottom face at operation 610. The portion of material forming the bottom face that is removed decreases as distance from the top plate leading edge increases. In some cases, the method may further (and optionally) include removing at least a portion of the inside face at operation 620. The portion of the inside face that is removed may decrease as distance from the side plate leading edge increases. The top plate may further include a top face that is opposite the bottom face. A distance between the bottom face and the top face may increase as distance from the top plate leading edge increases. In some cases, the removal of at least the portion of material forming the bottom face may be accomplished via grinding.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A cutting chain for a chainsaw, the chain comprising:
a plurality of drive links; and
a plurality of cutter links operably coupled to respective ones of the drive links
wherein at least one of the cutter links comprises:
a base portion; and
a cutting portion extending away from the base portion, the cutting portion including a side plate and a top plate, the top plate including a top plate leading edge and a bottom face, the side plate including a side plate leading edge and an inside face,
wherein the at least one of the cutter links is modified such that at least a portion of material forming the bottom face is removed, and
wherein the portion of material forming the bottom face that is removed decreases as distance from the top plate leading edge increases.

2. The cutting chain of claim 1, wherein at least a portion of the inside face is also removed.

3. The cutting chain of claim 2, wherein the portion of the inside face that is removed decreases as distance from the side plate leading edge increases.

4. The cutting chain of claim 1, wherein the top plate further includes a top face that is opposite the bottom face, and wherein a distance between the bottom face and the top face increases as distance from the top plate leading edge increases.

5. The cutting chain of claim 1, wherein the removal of material is accomplished via grinding.

6. The cutting chain of claim 5, wherein the removal of material creates a cutter link trench that extends from the top plate downward toward the base portion.

7. The cutting chain of claim 6, wherein a depth gauge extends upward from the base portion in front of a gap by an amount sufficient to put a top of the depth gauge in between a top and bottom of the cutter link trench.

8. A method of modifying a cutter of cutting chain for a chainsaw, the method comprising:
forming the cutter link to include a base portion and a cutting portion extending away from the base portion the cutting portion including a side plate and a top plate, the top plate including a top plate leading edge and a bottom face, the side plate including a side plate leading edge and an inside face; and
removing at least a portion of material forming the bottom face,
wherein the portion of material forming the bottom face that is removed decreases as distance from the top plate leading edge increases.

9. The method of claim 8, further comprising removing at least a portion of the inside face.

10. The method of claim 9, wherein the portion of the inside face that is removed decreases as distance from the side plate leading edge increases.

11. The method of claim 8, wherein the top plate further includes a top face that is opposite the bottom face, and wherein a distance between the bottom face and the top face increases as distance from the top plate leading edge increases.

12. The method of claim 8, wherein the removing at least the portion of material forming the bottom face is accomplished via grinding.

13. The method of claim 12, wherein the removal of material creates a cutter link trench that extends from the top plate downward toward the base portion.

14. The method of claim 13, wherein a depth gauge extends upward from the base portion in front of a gap by an amount sufficient to put a top of the depth gauge in between a top and bottom of the cutter link trench.
